(19) United States
(12) Patent Application Publication
(10) Pub. No.: US 2026/0276107 A1
(43) Pub. Date: Sep. 17, 2026

(54) FIXING STRUCTURE OF WIRING OR PIPING

(71) Applicant: FUJIKIN INCORPORATED, Osaka (JP)

(72) Inventors: Atsushi HIDAKA, Osaka-shi (JP); Keiji HIRAO, Osaka-shi (JP); Ichiro TOKUDA, Osaka-shi (JP); Yuta AYAI, Osaka-shi (JP); Daiki ITO, Osaka-shi (JP)

(73) Assignee: FUJIKIN INCORPORATED, Osaka (JP)

(21) Appl. No.: 19/164,040

(22) PCT Filed: Mar. 18, 2024
(86) PCT No.: PCT/JP2024/010627

§ 371 Date: Sep. 10, 2025

(30) Foreign Application Priority Data
Apr. 11, 2023 (JP) 2023-064360

(51) Int. Cl. F16L 5/00; H02G 3/22

(52) U.S. Cl. CPC F16L 5/00; H02G 3/22

(57) ABSTRACT

A fixing structure 10 is used for fixing wiring 20 or piping led out from a gas box 30 and comprises a fixing member constituted by a clamping member 14 for clamping a part of the wiring 20 or the piping from outside, and a plate member 16 for placing at least a part of the bottom surface of the clamping member 14 thereon.

### TECHNICAL FIELD

The present invention relates to a fixing structure for wiring or piping, and more particularly, to a fixing structure for fixing wiring or piping extended from a gas box.

### BACKGROUND ART

Conventionally, a gas supply system for supplying a process gas to a chamber is used in a semiconductor manufacturing device or the like. Patent Literature 1 discloses an embodiment of supplying a process gas to a chamber by using a gas box collectively accommodating flow rate controllers and valves provided in a plurality of gas supply lines.

The gas box is used, for example, to prevent outflow to surroundings and improve safety when gas leakage occurs. An exhaust passage may be connected to the gas box so that the leaked gas does not flow out to the surroundings. In addition, an inert gas such as nitrogen gas may be filled in the gas box in order to prevent the leaked gas from reacting with air.

A gas box used to cope with a leak gas from a gas supply system is required to have a corresponding airtightness. As the gas box, for example, a box formed by welding a sheet metal surrounding a periphery of a metal frame member is used.

### PRIOR ART LITERATURE

### Patent Documents

Patent Literature 1: Japanese Laid Open Patent Publication No. 2003-257870
Patent Literature 2: Japanese Laid Open Patent Publication No. 2003-257542
Patent Literature 3: Japanese Laid Open Patent Publication No. 2012-84317
Patent Literature 4: International Publication No. WO2022/091713

### SUMMARY OF INVENTION

### Problems to be Solved by Invention

When accommodating the components of the gas supply system, the gas box is provided with a hole for passing through wiring or piping connected to an external device. However, as described above, the gas box is required to have corresponding airtightness, and gas leakage must be suppressed from the periphery of the holes, through which the wiring or piping passes.

In order to suppress the leakage from the periphery of the hole, it is conceivable to minimize the number of holes or reduce the diameter of the holes as much as possible. However, in order to collectively accommodate devices having various functions in the gas box, it is often necessary to draw a corresponding number and size of wiring from the gas box.

Further, the wiring or piping extending from the gas box may be damaged by rubbing against the edge of the hole due to vibration of the device or the like. For this reason, it is preferable that the wiring is securely fixed to the gas box and protected.

In general, for the purpose of protecting the wiring extending from a housing, a rubber grommet is used to cover the edge of the hole provided in the housing. However, since sufficient sealability cannot be ensured by using the grommet alone, in some cases, it is not possible to sufficiently cope with a situation where an interior gas that is high-risk and high-reactive may leak, such as a gas box. In addition, when drawing a plurality of wires out of the box, it is troublesome to fit the grommets into the holes on the housing side with respect to each wire.

In addition, an explosion-proof measure is required according to the standard for wiring and electric equipment arranged in an environment where a combustible gas may be present. Patent Literatures 2 and 3 disclose explosion-proof connectors for drawing out wiring to outside while ensuring sealability of the box and non-contact between the wiring and the gas. Even though using such explosion-proof connectors are suitable for ensuring sealability of the box, it leads to a significant increase in manufacturing costs.

Therefore, particularly in a gas supply system, it is advantageous to have a fixing structure capable of drawing out a plurality of wires and pipes from the gas box to outside while ensuring sufficient sealability with a relatively simple structure.

The present invention has been made in order to solve the above-described problem, and a main object of the present invention is to provide a fixing structure that is relatively inexpensive and capable of drawing out wiring or piping while providing sufficient airtightness to a gas box.

### Means for Solving Problem

The fixing structure according to an embodiment of the present invention is a fixing structure for fixing wiring or piping led out from a gas box, using a clamping member for clamping a portion of the wiring or piping from outside, and a plate member for placing at least a portion of a bottom surface of the clamping member thereon.

In one embodiment, a cylindrical tube is fixed to an outer periphery of the wiring or piping, and the clamping member is configured to sandwich an outer side of the cylindrical tube fixed to the wiring or piping.

In one embodiment, the fixing member is fixed to the gas box with the cylindrical tube passing through a hole provided in the gas box.

In one embodiment, the plate member includes a placing portion for placing the clamping member, and a fixing portion for fixing the cylindrical tube between the placing portion and the fixing porting with the clamping member being placed on the placing portion.

In one embodiment, the placing portion and the fixing portion of the plate member have a same thickness.

In one embodiment, the clamping member is made of resin, and the plate member is made of metal.

### Effect of Invention

According to the fixing structure for wiring or piping of the embodiments of the present invention, it is possible to appropriately fix the wiring or piping led out from the gas box while providing sufficient sealability to the gas box.

### BRIEF DESCRIPTION OF DRAWINGS

FIG. 1 is a cross-sectional view of the fixing structure for wiring according to an embodiment of the present invention.

FIG. 2 is an exploded perspective view indicating a detailed configuration of a fixing structure for wiring according to an embodiment of the present invention.

FIG. 3 is a perspective view of the clamping member and the plate member sandwiching the wiring when seen from a bottom direction.

FIG. 4 is an exploded perspective view indicating a detailed configuration of a fixed structure for wiring according to another embodiment of the present invention, (a) shows the clamping member, and (b) shows the plate member.

### DETAILED DESCRIPTION OF EMBODIMENTS

Hereinafter, embodiments of the present invention will be described in detail with reference to the drawings, but the present invention is not limited to the embodiments described below. Further, although the fixing structure for wiring is described below, the fixing structure for wiring can be used as a fixing structure for piping as the same.

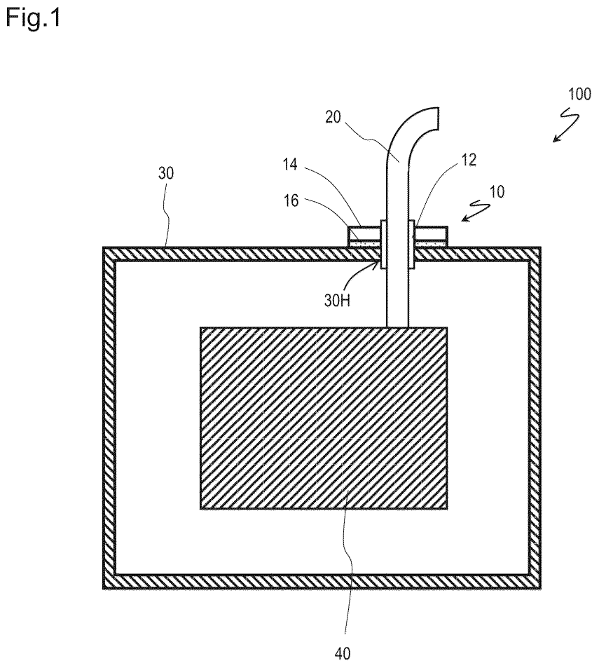

FIG. 1 shows a gas supply unit 100 with wiring 20 fixed to a gas box 30 by using a fixing structure 10 for wiring according to an embodiment of the present invention. A gas processing device 40 incorporated in the gas supply system is accommodated inside the gas box 30.

The gas processing device 40 disposed inside the gas box 30 may have various configurations. The gas processing device 40 may include a flow rate control device or a vaporizer, and may include, for example, a plurality of vaporization supply devices collectively provided for each line described in Patent Literature 4. However, the present invention is not limited to this embodiment, and the gas processing device 40 may be any gas supply line component that can cause gas leakage, such as a pipe, a flow path block, or a fluid device (valve or the like).

Although not shown, a raw material inlet pipe in which a raw material of a gas or a liquid flows and a gas outlet pipe from which a raw material gas flows out may be connected to the gas processing device 40. These raw material inlet and gas outlet pipes are also typically in communication with a joint located outside of the gas box 30.

In the present embodiment, a filling gas supply pipe (not shown) is connected to the gas box 30, and the inside of the gas box 30 is typically supplied with an inert gas (here, nitrogen gas) having a pressure of at least the atmospheric pressure. Accordingly, even when a gas leaks from the gas processing device 40, the leaked gas is prevented from reacting with oxygen in the air. In order to prevent the inflow of ambient air into the gas box 30, it is desirable that the pressure of the inert gas in the gas box 30 be maintained at or above an external pressure (typically the atmospheric pressure).

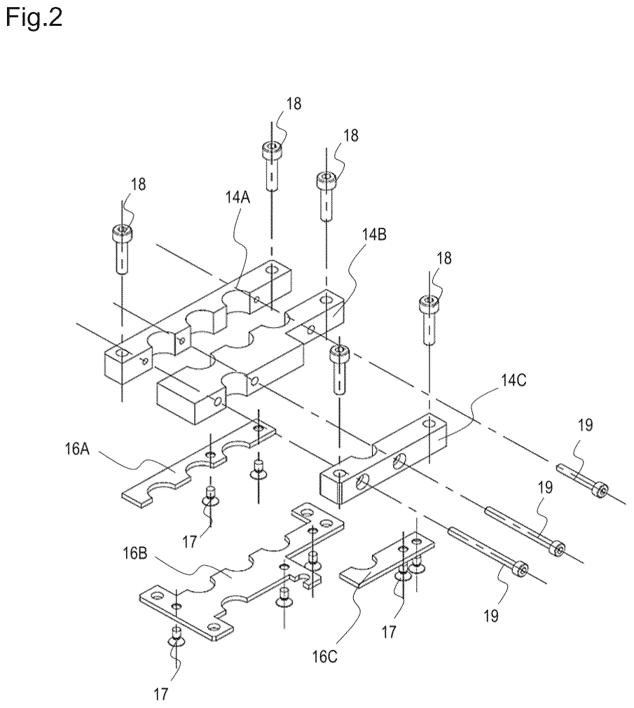

Hereinafter, a detailed configuration of the fixing structure 10 of the present embodiment will be described with reference to FIGS. 1 and 2. For convenience, the plane in contact with the gas box 30 in the fixing structure 10 may be referred to as a bottom surface, and the plane on the opposite side thereof may be referred to as an upper surface, but the upper surface and the bottom surface may be different from the actual vertical direction depending on the location where the fixing structure 10 is disposed.

As shown in FIG. 1, the fixing structure 10 includes a cylindrical tube 12 made of resin material fixed to an outer periphery of the wiring 20, a clamping member 14 made of resin material for clamping a part of the cylindrical tube 12 from outside, and a plate member 16 made of metal material with at least a part of a bottom surface of the clamping member 14 placed thereon. The fixing structure 10 is fixed on the outer surface of the gas box 30 with the cylindrical tube 12 passing through a hole 30H provided in the gas box 30.

The cylindrical tube 12 is provided so as to be easy to handle a plurality of wires in a bundle and so as not to be damaged even if the wiring is in contact with the metal plate or the like. The material of the cylindrical tube 12 is, for example, silicone rubber or fluorine resin (PFA, FEP, or the like). The clamping member 14 is made of, for example, PEEK (Poly Ether Ether Ketone), and the plate member 16 is made of, for example, stainless steel. By using such materials, sealing and fixing can be appropriately performed even when a high temperature gas is treated in the gas processing device 40 (for example, when a gas of 200° C. is generated using a vaporizer as described above). However, in a case where the fixing structure 10 does not require high temperature resistance, such as when the temperature of the processing gas is low, the clamping member 14 may be formed of other resin material.

In some cases, the cylindrical tube 12 is not used when there is no necessity, such as when the wiring 20 is only one wire, the piping is made of metal, or the structure is made of a material that is not easily damaged.

The plate member 16 is preferably made of a material having a hardness at least higher than that of the clamping member 14. As will be described later, the plate member 16 is closely fixed to the clamping member 14 and firmly fixed to the gas box 30. At this time, in order to effectively prevent gas leakage from the periphery of the hole 30H, it is advantageous that the bottom surface of the plate member 16 is as flat as possible and hardly deformed in order to enhance adhesivity and sealability. Further, as the plate member 16, by using a material having higher processing accuracy than the clamping member 14, the tolerance of the screw hole is relatively small even being screwed to the gas box 30 and can be positioned more accurately. As a result, the sealability can be improved as compared with a case where only the clamping member 14 is screwed and fixed to the gas box 30.

FIG. 2 shows a more specific configuration of the clamping member 14 and the plate member 16. In the present embodiment, the clamping member 14 is constituted by three parts: a first clamping member 14A, a second clamping member 14B, and a third clamping member 14C. At least one of the connecting surfaces between the first clamping member 14A and the second clamping member 14B is provided with a recess, and when the first clamping member 14A and the second clamping member 14B are combined, the wiring 20 and the cylindrical tube 12 covering the outer side thereof shown in FIG. 1 can be tightly sandwiched.

Here, in the embodiment shown in FIG. 2, each of the first clamping member 14A and the second clamping member 14B is provided with three semicircular recesses facing each other so as to sandwich three wires each covered with a cylindrical tube. However, the present invention is not limited thereto, and each recess may have an arbitrary shape to conform to the cross-sectional shape of the wire and the cylindrical tube, and the recess may not necessarily be provided in both of the clamping members as long as the cylindrical tube can be tightly sandwiched. For example, in a case where the wiring section including the cylindrical tube has a rectangular shape, a corresponding rectangular concave portion may be provided in only one of the clamping members, and the other clamping member may be flat or have a convex portion. Further, although a structure of sandwiching three wires is described here, it is needless to say that the number of recesses can be increased or decreased in accordance with the number of wires to be taken out.

In addition, in the embodiment shown in FIG. 2, a recessed portion is also provided at one location on each of the surfaces of the second clamping member 14B and the third clamping member 14C facing each other. In this configuration, when the second clamping member 14B and the third clamping member 14C are combined, a single wire 20 and the cylindrical tube 12 covering the outer side thereof can be tightly sandwiched. However, the present invention is not limited thereto, same as the first clamping member 14A and the second clamping member 14B, the shapes and numbers of the recesses can be changed according to the applications.

When the clamping member 14 is used, the sealability can be improved by substantially eliminating the gap between the resin clamping member 14 and the wiring on the upper surface of the hole 30H provided in the gas box 30. Therefore, it is easy to maintain the pressure of an inert gas such as nitrogen gas filled in the gas box 30 higher than the atmospheric pressure.

A diameter of a gap, formed by the clamping member 14, for passing the wiring 20, may be formed to be slightly smaller than an outer diameter of the cylindrical tube 12. Thus, the gap between the clamping member 14 and the cylindrical tube 12 can be filled. However, if the outer diameter of the cylindrical tube 12 is too large, a gap may be formed between the clamping members, and therefore, it is preferable that the size is not significantly different. Alternatively, when the cylindrical tube 12 is made of a deformable member, the deformation can suppress the formation of gap when the clamping member is tightened.

In addition, if only a cable or an air tube, of which the outer skin part is made of resin or the like, pass through the hole 30H, the outer skin may be damaged by contacting with the metal plate each time when the wiring or the like moves, and electric leakage may occur due to the exposure of the inner wiring part, or a hole may be formed in the air tube. In contrast, in a manner of sandwiching the cylindrical tube 12, by fixing the clamping member 14 to the gas box 30, it is possible to prevent damage to the wiring and tube.

In addition, it is advantageous to arrange the cable, the air tube, and the like, in a bundle as much as possible due to the relationship, such as a connection, with another device. On the other hand, by using a fixing structure 10, it is possible to firmly fix the plurality of cables and air tubes to the gas box 30 in a bundle.

Further, in the present embodiment, since the plate member 16 is fixed to the bottom surface of the clamping member 14 and then fixed to the gas box 30, even when there is a tolerance in the screw hole of the plate member 16, the clamping member 14 is prevented from being fixed in a misaligned state with less sealability. By using the plate member 16, the bottom surface of the fixing structure 10 becomes flat, so that a step or the like is formed in the clamping member sandwiching the cylindrical tube 12, thus to prevent a gap from being formed between one of the clamping members and the gas box, thereby eliminating gas leak.

As illustrated in FIG. 2, the plate member 16 of the present embodiment includes a placing portion 16B, a first fixing portion 16A, and a second fixing portion 16C. The thickness of the placing portion 16B, the first fixing portion 16A, and the second fixing portion 16C are typically the same.

All of the first clamping member 14A, the second clamping member 14B, and the third clamping member 14C are placed on the placing portion 16B. The placing portion 16B is fixed to the second clamping member 14B by a fastening screw 17. Here, the second clamping member 14B is entirely placed on the placing portion 16B. On the other hand, for the first clamping member 14A and the third clamping member 14C, only a part, through which the fixing screw 18 reaching the gas box 30 passes, is placed on the placing portion 16B.

Further, the first fixing portion 16A has a planar shape that is fitted to one side of the placing portion 16B and is fixed to the bottom surface of the first clamping member 14A by the fastening screw 17. Similarly, the second fixing portion 16C has a planar shape that is fitted to the opposing side of the placing portion 16B and is fixed to the bottom surface of the third clamping member 14C by the fastening screw 17.

Consequently, the first clamping member 14A is placed on the upper surfaces of the first fixing portion 16A and the placing portion 16B, and the third clamping member 14C is placed on the upper surfaces of the second fixing portion 16C and the placing portion 16B.

Three semicircular recesses are provided on the facing surface (side surface) of the first fixing portion 16A and the placing portion 16B respectively so as to correspond to the clamping member 14. Similarly, one semicircular recess is provided in each of the facing surfaces of the placing portion 16B and the second fixing portion 16C. Thus, the wiring can pass through the plate member 16. The first fixing portion 16A and the second fixing portion 16C may fix the cylindrical tube 12 to the placing portion 16B in between. However, the structure and the number of the recesses formed in the first fixing portion 16A, the second fixing portion 16C, and the placing portion 16B are formed in accordance with the structure and the number of the recesses formed in the first clamping member 14A, the second clamping member 14B, and the third clamping member 14C.

As described above, by forming a substantially closed hole for passing the wiring through the surface facing the placing portion 16B, the fixing portions 16A and 16C without any gap, it is possible to enhance the sealability of the plate member to the side.

Attachment of the fixing structure 10 to the gas box 30 is performed, for example, as follows. First, inserting a cable, etc. (wiring or piping to be fixed) into the cylindrical tube 12. A shrink tube can also be used as the cylindrical tube 12.

Next, sandwiching the corresponding cylindrical tube 12 between the first clamping member 14A and the second clamping member 14B, and sandwiching another corresponding cylindrical tube 12 between the second clamping member 14B and the third clamping member 14C, and placing them on the placing portion 16B of the plate member 16. Then, fixing the first clamping member 14A, the second clamping member 14B, and the third clamping member 14C to each other by fastening a lateral screw 19 thereto.

Next, fixing the first fixing portion 16A, the placing portion 16B, and the second fixing portion 16C to the first clamping member 14A, the second clamping member 14B, and the third clamping member 14C respectively by the fastening screw 17, in a state where the first fixing portion 16A and the second fixing portion 16C of the plate member 16 are fitted into the step portion of the placing portion 16B. Thus, the fixing member, with the plate member 16 attached to the bottom surface thereof, is completed in a state where the wiring 20 and the cylindrical tube 12 are sandwiched by the clamping member 14.

Next, in a state where the wiring 20 is passing through the hole portion 30H of the gas box 30, placing the fixing member (the clamping member 14 and the plate member 16) on the upper surface of the gas box 30, and this can be attached to the gas box 30 by tightening the fixing screw 18 inserted from the top of the fixing hole of the clamping member 14.

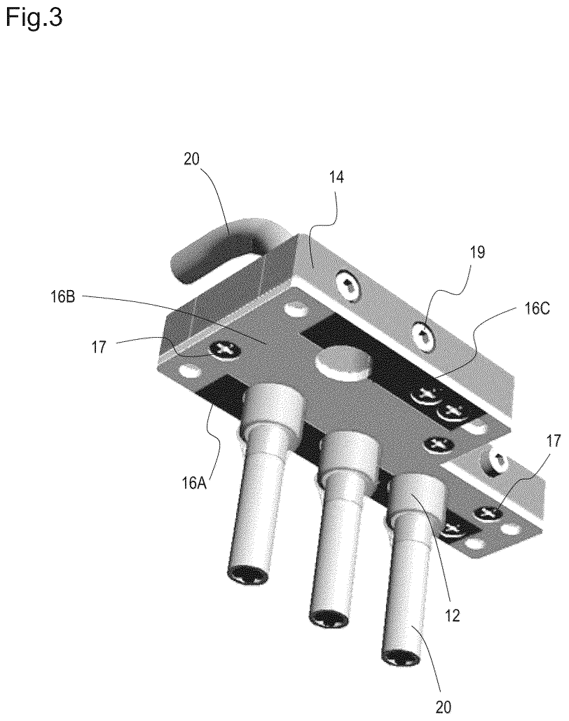

FIG. 3 is a perspective view of the clamping member 14 and the plate member 16 (the first fixing portion 16A, the placing portion 16B, and the second fixing portion 16C) sandwiching the wiring 20 and the cylindrical tube 12 when viewed from the bottom surface. Note that, FIG. 3 shows a state where a cylindrical tube is not sandwiched between the second clamping member and the third clamping member, and a hole is open, but it is for easy viewing of the drawing, and in practice, the cylindrical tube is also sandwiched in this part.

As can be seen from FIG. 3, the plate member 16, which is relatively hard and flat, is arranged on the bottom surface, and is easily attached to the gas box 30 without any gap. Further, since the clamping member 14 is also disposed on the same surface of the plate member 16 (particularly, the placing portion 16B), a step or a gap is less likely to occur between the clamping member 14 and the plate member 16. As a result, the sealability in the vicinity of the wiring lead-out portion can be improved even after being attached to the gas box 30.

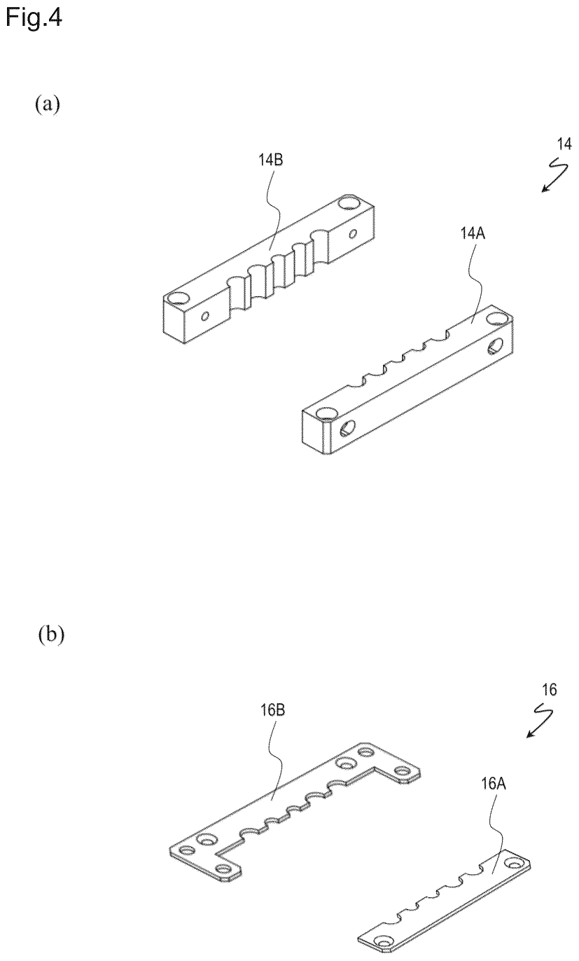

FIG. 4 illustrates another embodiment of the clamping member 14 and the plate member 16. In this embodiment, the clamping member 14 includes two members, the first clamping member 14A and the second clamping member 14B, and the plate member 16 includes two members, the first fixing portion 16A and the placing portion 16B.

Also in this embodiment, a fixing member can be formed by fixing the first clamping member 14A and the second clamping member 14B to each other while sandwiching the wiring or piping, placing these on the placing portion 16B, fitting the first fixing portion 16A, and fastening and fixing the clamping member and the plate member by a fastening screw. Also in this embodiment, a gap is less likely to form between the plate member and the upper surface of the gas box, and also a gap is less likely to form between the plate member and the clamping member, thus the sealability of the gas box can be improved, and the inert gas inside can be easily maintained at an atmospheric pressure or higher.

The present invention is not limited to the embodiment described above, and various modifications can be made. For example, the plate member does not necessarily have to be composed of a plurality of members, and may have a configuration of only a placing portion provided with a hole through which wiring or the like passes (a configuration in which the placing portion and the fixing portion described above are integrated). However, in this case, since sandwiching the wiring by the clamping members, and fixing the clamping member and the plate member are performed after passing the wiring or the like through the hole of the plate member in advance, it has advantageous to use the above-described separated plate member for easy operation.

### INDUSTRIAL APPLICABILITY

The fixing structure of wiring or piping according to the embodiment of the present invention is preferably utilized for securely fixing wiring or piping extended from a gas processing device disposed inside a gas box, even a plurality of wires and pipes can be fixed in a bundle to the gas box with high sealability.

### REFERENCE SIGNS LIST

10 Fixing structure
12 Cylindrical tube
14 Clamping member
16 Plate member
16A Fixing portion
16B Placing portion
20 Wiring
30 Gas box
40 Gas processing device
100 Gas supply unit

1. A fixing structure for fixing wiring or piping led out from a gas box, using a fixing member comprising:
a clamping member for clamping a part of the wiring or piping from outside, and
a plate member for placing at least a part of a bottom surface of the clamping member thereon.

2. The fixing structure according to claim 1, wherein a cylindrical tube is fixed to an outer periphery of the wiring or the piping, and the clamping member is configured to sandwich an outer side of the cylindrical tube fixed to the wiring or the piping.

3. The fixing structure according to claim 2, wherein the fixing member is fixed on the gas box in a state where the cylindrical tube passes through a hole provided in the gas box.

4. The fixing structure according to claim 2, wherein the plate member includes a placing portion for placing the clamping member thereon, and a fixing portion for fixing the cylindrical tube between the placing portion and the fixing portion, in a state where the clamping member is placed on the placing portion.

5. The fixing structure according to claim 4, wherein the placing portion and the fixing portion of the plate member have a same thickness.

6. The fixing structure according to claim 1, wherein the clamping member is made of resin, and the plate member is made of metal.
